(19) United States
(12) Patent Application Publication
(10) Pub. No.: US 2015/0280310 A1
(43) Pub. Date: Oct. 1, 2015

(54) KEYBOARD MODULE WITH ANTENNA UNIT AND ELECTRONIC DEVICE USING THE SAME

(71) Applicant: Chun-Heng LEE, Taoyuan County (TW)

(72) Inventor: Chun-Heng LEE, Taoyuan County (TW)

(21) Appl. No.: 14/672,300

(22) Filed: Mar. 30, 2015

(30) Foreign Application Priority Data
Mar. 31, 2014 (TW) 103112020

(51) Int. Cl. H01Q 1/22; H01H 13/86

(52) U.S. Cl. CPC H01Q 1/2266; H01H 13/86

(57) ABSTRACT

The present application provides a keyboard module and an electronic device using a keyboard module. The keyboard module comprises a housing structure having an accommodation room; a push button unit having a plurality of push elements disposed in the accommodation room; and a near field communication antenna unit including an antenna body disposed between a bottom of the accommodation room and the push elements, wherein the antenna body has a specified distance from the bottom of the accommodation room.

### FIELD OF THE INVENTION

The present invention relates to a keyboard module, and more particularly to a keyboard module with an antenna unit. The present invention also relates to an electronic device using a keyboard module.

### BACKGROUND OF THE INVENTION

An antenna is commonly used for transmitting and receiving electromagnetic waves in a wireless communication system. A change in either of both of design and position of an antenna in the system would change an antenna pattern of the antenna, and further affect the communication quality of a wireless signal.

Please refer to FIG. 1, which is a perspective view schematically showing appearance of a conventional notebook (computer) with a hidden antenna unit. As shown in the figure, the conventional notebook 1 comprises an upper part 11 and a lower part 12, wherein the upper part 11 is primarily disposed with a liquid crystal display 111, and two hidden antennas 13 are symmetrically disposed at an upper edge relative to the liquid crystal display 111 for antenna diversity. An RF coaxial cable 14 is used as a feed-in line of the hidden antenna 13 for transmitting an RF electronic signal between the hidden antenna 13 and a wireless antenna module 15 in the lower part 12.

Although being capable of transmitting and receiving electromagnetic waves, the hidden antennas shown in FIG. 1 have to occupy certain room of the upper part 11 and thus adversely affect the thinning tendency of designs for the upper part 11 of the notebook 1. Therefore, the notebook with the hidden antenna disposed in the lower part 12 is developed.

Please refer to FIG. 2, which is a perspective view schematically showing another conventional notebook with a hidden antenna unit disposed in the lower part thereof. As shown in the figure, the hidden antenna unit 22 is disposed in the lower part 21 of the conventional notebook 2 corresponding to a touch pad 23 of the notebook 2. An RF wireless communication, for example a near field communication (NFC), between the notebook 2 and a communication device, such as a contactless credit card or a smart phone, can be conducted to exchange data with each other via the hidden antenna unit 22.

The NFC allows contactless point-to-point data transmission between the notebook 2 and the communication device within a short range. When the notebook 2 executes NFC with a communication device (not shown in the figure), the communication device is placed above the touch pad 23 of the notebook 2 to communicate with the hidden antenna unit 22 under the touch pad 23. While NFC is being executed, the touch pad 23 might be undesirably activated due to the interference of a magnetic force generated from the hidden antenna unit 22 and passing through the touch pad 23. Since the touch pad 23 is supposed to generate a sensing current only in response to a sensed capacitance between the electrodes of the touch pad 23 and a finger approaching the electrodes, the magnetic force might undesirably induce the electrodes of the touch pad 23 to generate a false sensing current.

### SUMMARY OF THE INVENTION

One object of the present invention is to provide a keyboard module with antenna unit, and an electronic device using a keyboard module. By using the keyboard module provided in the present invention, the problem of a conventional notebook with a hidden antenna unit disposed at a position corresponding to the touch pad, which might be undesirably activated due to the interference of a magnetic force generated from the hidden antenna unit and passing through the touch pad, can be improved.

Another object of the present invention is to provide a keyboard module with antenna unit and an electronic device using a keyboard module so that an antenna body of a near field communication antenna unit can be disposed at a lower part of an electronic device while keeping good communication capability.

In order to achieve at least one of the objects described above, one embodiment of the present invention provides a keyboard module comprising: a housing structure having an accommodation room; a push button unit having a plurality of push elements disposed in the accommodation room; and a near field communication antenna unit including an antenna body disposed between a bottom of the accommodation room and the push elements, wherein the antenna body has a specified distance from the bottom of the accommodation room.

Wherein, the housing structure comprises a keyboard frame, the keyboard frame comprises a frame body and a plurality of through holes penetrating through the frame body, the push elements correspond to the through holes respectively, the antenna body is disposed between the bottom of the accommodation room and the frame body, and a spacing distance between the antenna body and a surface of the push button unit is shorter than an activity distance.

Wherein, the keyboard module further includes a buffer unit disposed between the antenna body and the bottom of the accommodation room so that the bottom of the accommodation room has the specified distance from the antenna body, wherein the buffer unit is non-metal or magnetically permeable.

Wherein, the keyboard module comprises an electromagnetically insulating structure disposed between the push elements and the bottom of the accommodation room of the housing structure, and the antenna body is disposed above the electromagnetically insulating structure.

Wherein, the near field communication antenna unit further comprises a magnetic conducting layer attached onto a surface of the antenna body adjacent to the electromagnetically insulating structure for facilitating transmission of a magnetic force through the magnetic conducting layer, thereby allowing the specified distance to be reduced, wherein the magnetic conducting layer is ferrite.

Wherein, the antenna body is implemented with at least one of the following: a metal conductor, an iron plate, an enameled wire, a conducting line and an antenna chip on a flexible circuit board.

Wherein, the keyboard module comprises a circuit board, and the antenna body is disposed on the circuit board.

In order to achieve at least one of the objects described above, another embodiment of the present invention provides an electronic device comprising: an upper part; and a lower part coupled to the upper part and comprising a keyboard module, wherein the keyboard module comprises a housing structure, a push button unit and an antenna unit, the housing structure comprises an accommodation room, the push button unit comprises an electromagnetically insulating structure and a plurality of push elements, the push elements are disposed above the electromagnetically insulating structure, the antenna unit comprises an antenna body, the antenna body is disposed between the electromagnetically insulating structure and the push elements and has a specified distance from the electromagnetically insulating structure.

In order to achieve at least one of the objects described above, a further one embodiment of the present invention provides a keyboard module comprising: a housing structure having an accommodation room; a push button unit having a plurality of push elements disposed in the accommodation room; and an antenna unit having an antenna body disposed between a bottom of the accommodation room and the push elements, wherein the antenna body has a specified distance from the bottom of the accommodation room.

### BRIEF DESCRIPTION OF THE DRAWINGS

The present invention will become more readily apparent to those ordinarily skilled in the art after reviewing the following detailed description and accompanying drawings, in which:

FIG. 1 is a perspective view schematically showing appearance of a conventional notebook with a hidden antenna unit.

FIG. 2 is a perspective view schematically showing another conventional notebook with a hidden antenna unit disposed in the lower part thereof.

FIG. 3 is a perspective view schematically showing an electronic device in accordance with a preferred embodiment of the present invention.

FIG. 4 is a schematic diagram showing appearance of the keyboard module in FIG. 3.

FIG. 5 is a perspective view schematically showing the keyboard module in FIG. 3 after removing frames and a part of push elements.

FIG. 6 is a schematic diagram showing a cross-sectional view of a part of the keyboard module in FIG. 3.

FIG. 7 is a schematic diagram showing a cross-sectional view of a part of the keyboard module shown in FIG. 3 in accordance with another embodiment of the present invention.

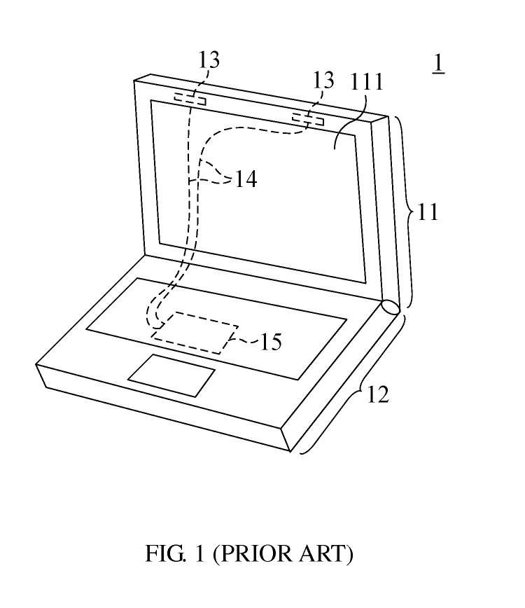

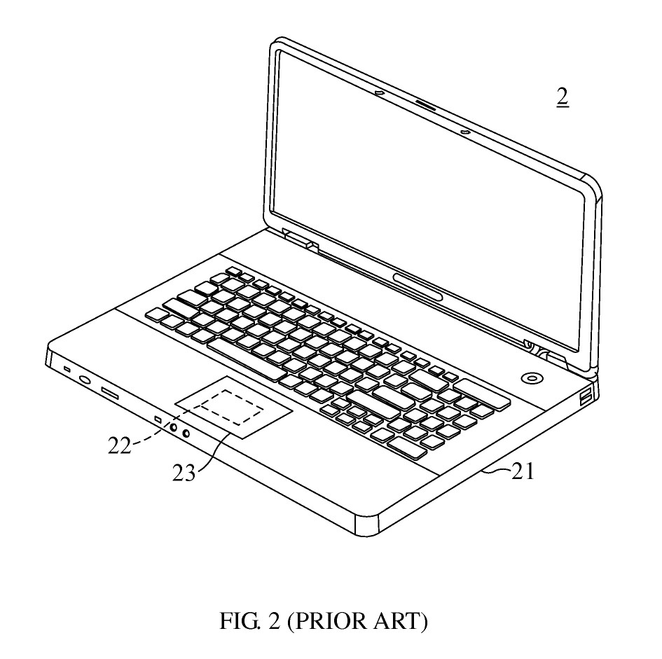

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

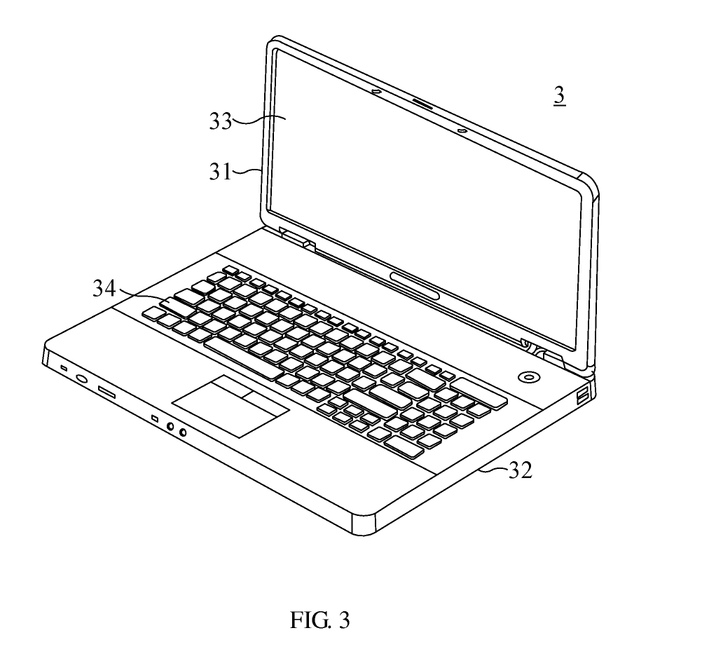

Please refer to FIG. 3, which is a perspective view schematically showing an electronic device in accordance with a preferred embodiment of the present invention. As shown in the figure, the electronic device 3 comprises an upper part 31 and a lower part 32. The upper part 31 comprises a panel module 33 such as a liquid crystal display. The lower part 32 comprises a keyboard module 34, and the keyboard module 34 used in the present invention could be a keyboard structure of any type, for example a mechanical keyboard structure, an X-type keyboard structure, a metal-sheet keyboard structure or a carbon-film contacting keyboard structure. In the present embodiment, the electronic device 3 can be, but is not limited to, a notebook. Obviously, the lower part 32 further comprises other electronic components, for example a mainboard or a transmitting port (not shown in this figure), which are commonly disposed in a conventional notebook.

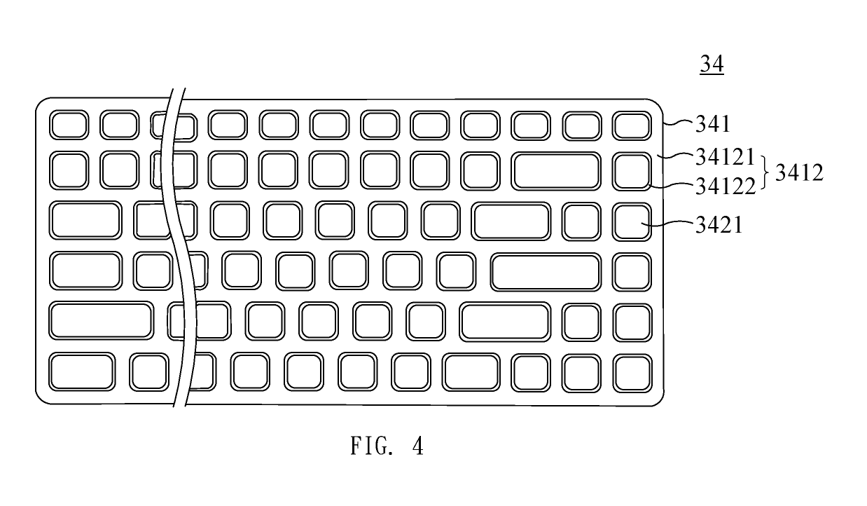

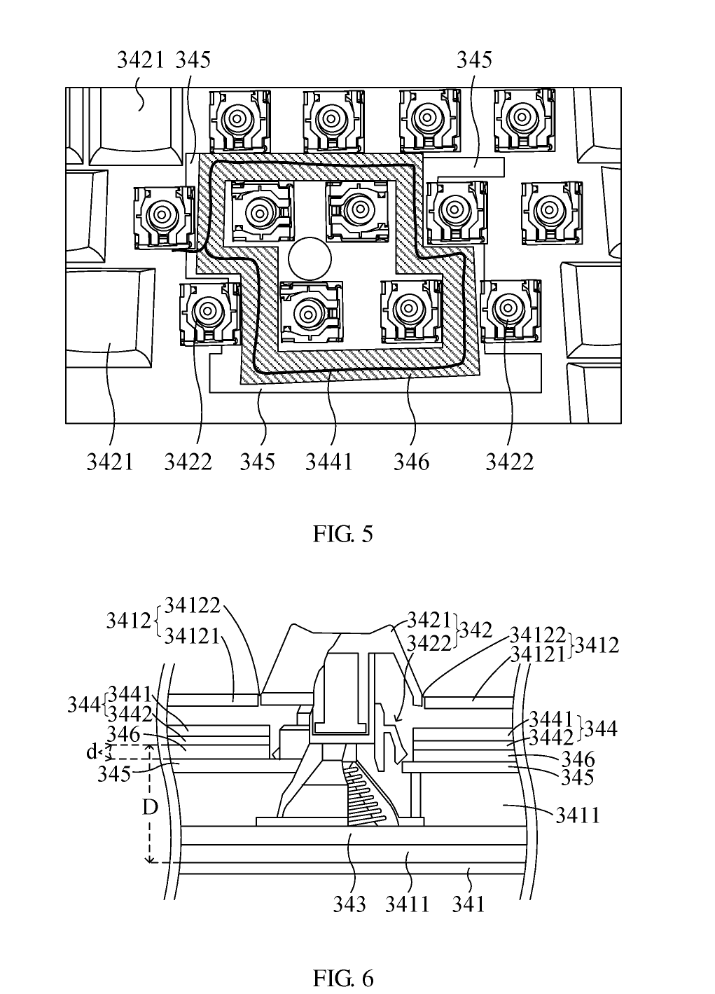

Please refer to FIG. 4, FIG. 5 and FIG. 6, wherein FIG. 4 is a schematic diagram showing appearance of the keyboard module in FIG. 3, FIG. 5 is a perspective view schematically showing the keyboard module in FIG. 3 after removing frames and a part of push elements, and FIG. 6 is a schematic diagram showing a cross-sectional view of a part of the keyboard module in FIG. 3. As shown in the figures, the keyboard module 34 comprises a housing structure 341, a push button unit 342, a circuit board 343 and an antenna unit 344. The housing structure 341 comprises an accommodation room 3411 and a keyboard frame 3412, wherein the keyboard frame 3412 comprises a frame body 34121 and a plurality of through holes 34122 penetrating through the frame body 34121. The push button unit 342 comprises a plurality of push elements 3421 and a plurality of button bodies 3422. The push elements 3421 and the button bodies 3422 are disposed in the accommodation room 3411 of the housing structure 341. Each push element 3421 is correspondingly disposed in a through hole 34122, and is assembled with a corresponded button body 3422 to enable the push element 3421 to move up and down relative to the corresponded through hole 34122. The button bodies 3422 of the push unit 342 can be signal connected to the circuit board 343, and the circuit board 343 is disposed between the bottom of the accommodation room 3411 and the push elements 3421.

Please refer to FIG. 5 and FIG. 6. The antenna unit 344 can be a near field communication antenna unit with an antenna body 3441 disposed between the bottom of the accommodation room 3411 of the housing structure 341 and the push elements 3421. Furthermore, the antenna body 3441 in the present invention need not to be electrically coupled to the frame body 34121 or contacted to the push button unit 342, so that the disposition of the antenna body 3441 would not influence original design and movement of the keyboard module 34. The antenna body 3441 could be implemented with at least one of the following: a metal conductor, an iron plate, an enameled wire, a conducting line and an antenna chip on a flexible circuit board. Please refer to FIG. 5, wherein the antenna body 3441 is made by enameled wires. Besides, size, direction and disposed position of the antenna 3441 are not limited and can be adjusted according to actual requirement. The antenna unit 344 could be a communication antenna unit for other purpose, for example a mobile network communication antenna, a wireless TV antenna or a satellite positioning antenna, etc.

Please refer to FIG. 5 and FIG. 6 again. The keyboard module 34 could further comprise an electromagnetically insulating structure 345, which can be a metal grounding layer or a metal plate, to prevent from generating electromagnetic interference between the antenna unit 344 and other circuit elements (not shown in this figure). The electromagnetically insulating structure 345 is disposed between the push elements 3421 and the bottom of the accommodation room 3411 of the housing structure 341. The bottom of the accommodation room 3411 could be replaced by metal or coated with conductive lacquer to be the electromagnetically insulating structure for preventing the antenna unit 344 from being interfered by the electronic components below the bottom of the accommodation room 3411 (for example: mainboard of the notebook, which is not shown in this figure). The electromagnetically insulating structure could also comprise a hollow region to achieve the effect of electromagnetic insulation.

Because transmittance or reception of the electromagnetic wave is affected by the condition of magnetic force generated from the antenna body 3411, an adequate distance between the antenna body 3441 and the electromagnetically insulating structure 345 should be kept so that the magnetic force generated from the antenna body 3441 would not be destroyed due to short distance between the antenna body 3411 and the electromagnetically insulating structure 345. Therefore, the keyboard module 34 could further comprise a buffer unit 346 disposed between the antenna body 3441 and the electromagnetically insulating structure 345, or between the antenna body 3441 and the bottom of the accommodation room 3411 of the housing structure 341, so that the bottom of the accommodation room 3411, or the electromagnetically insulating structure, has a specified distance from the antenna body 3441. The buffer unit 346 could be non-metal, for example sponge, or magnetically permeable.

Please refer to FIG. 6. The near field communication antenna unit 344 could further comprises a magnetic conducting layer 3442, which is but not limits to ferrite, attached onto a surface of the antenna body 3441 adjacent to the electromagnetically insulating structure 345 for facilitating transmission of the magnetic force through the magnetic conducting layer 3442, thereby allowing the specified distance to be reduced to improve the design flexibility.

The arrangement of the push elements 3421, the electromagnetically insulating structure 345, the antenna body 3441, the magnetic conducting layer 3442 and the buffer unit 346 would be described below referring to FIG. 6. As shown in the figure, the push elements 3421, the antenna body 3441, the magnetic conducting layer 3442 and the buffer unit 346 are disposed above the electromagnetically insulating structure 345, and the antenna body 3441, the magnetic conducting layer 3442 and the buffer unit 346 are disposed between the electromagnetically insulating structure 345 and the frame body 34121 of the keyboard frame 3412, or are disposed between the electromagnetically insulating structure 345 and the push elements 3421. The buffer unit 346 is disposed on the surface of the electromagnetically insulating structure 345, and the near field communication antenna unit 344 is disposed on the surface of the buffer unit 346. The magnetic conducting layer 3442 is disposed on the surface of the antenna body 3441 adjacent to the electromagnetically insulating structure 345, i.e. the magnetic conducting layer 3442 is disposed between the antenna body 3441 and the buffer unit 346. A proper specified distance d or D exists between the bottom of the accommodation room 3411 and the antenna body 341, or between the electromagnetically insulating structure 345 and the antenna body 341, by sandwiching the buffer unit 346 therebetween. The proper distance d or D between the bottom of the accommodation room 3411 and the antenna body 341, or between the electromagnetically insulating structure 345 and the antenna body 341, can be reduced by using the magnetic conducting layer 3442 to improve the design flexibility.

Accordingly, the drawback of disposing the antenna unit at the position corresponding to the touch pad in the conventional art can be improved by applying the technique solution of disposing the near field communication antenna unit 344 in the keyboard module 34 in the lower part 32 of the electronic device 3. Besides this, the efficiency of transmitting or receiving electromagnetic signals by the antenna body 3441 can be improved and the communication quality can be maintained by disposing the antenna body 3441 between the bottom of the accommodation room 3411 of the housing structure 341 and the push elements 3421, and further keeping a distance d or D between the antenna body 3441 and the electromagnetically insulating structure 345 or the bottom of the accommodation room 3411 to prevent the magnetic force generated by the antenna body 3441 from being destroyed due to the small distance between the antenna body 3441 and the electromagnetically insulating structure 345. Furthermore, a manufacturing process of the frame body 34121 need not to be changed to dispose the antenna body 3441 therein, and the antenna body 3441 need not to be electrically coupled or contacted to the push button unit 342. Therefore, disposition of the antenna body 3441 would not affect original design and operation of the keyboard module 34.

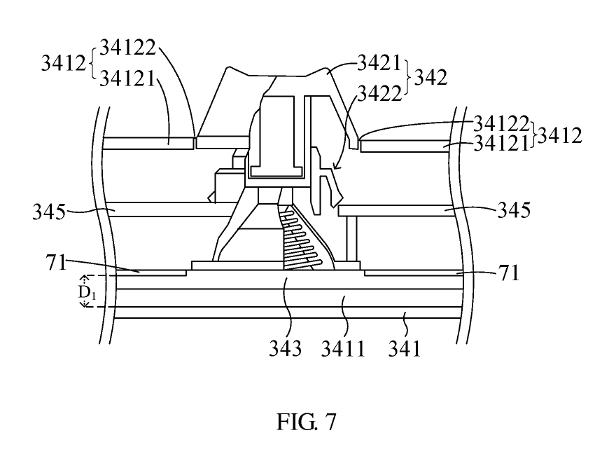

It should be noted that the position, where the antenna body 3441 is between the bottom of the accommodation room 3411 and the push elements 3421, is not limited to the embodiment shown in FIG. 6. Please refer to FIG. 7, which is a schematic diagram showing a cross-sectional view of a part of the keyboard module shown in FIG. 3 in accordance with another embodiment of the present invention. As shown in the figure, in the present embodiment, the antenna body 71 is disposed above the circuit board 343, that is, the antenna body 71 in integrated into the circuit board 343 of the keyboard module 34. A safety distance exists between the antenna body 71 and other conducting lines on the circuit board 343, or between the antenna body 71 and the electronic device with electromagnetically insulating effect, and a specified distance D1 also exists between the antenna body 71 and the bottom of the accommodation room 3411 of the housing structure 341 to prevent the magnetic force from being destroyed due to the small distance between the antenna body 71 and the bottom of the accommodation room 3411 of the housing structure 341, which is used as the electromagnetically insulating structure 345, so that the efficiency of transmitting or receiving the electromagnetic signals by the antenna body 71 can be improved to ensure a good communication quality.

The distance between antenna body 3441 or antenna body 71 and the bottom of the accommodation room 3411 may vary in accordance with requirement of environment and material. In FIG. 6 and FIG. 7 of the present invention, the distance between the antenna body 3441 or antenna body 71 and the bottom of the accommodation room 3411 of the housing structure 341 or the electromagnetically insulating structure ensures a good communication quality. Besides this, the distance between the antenna body 3441 or antenna body 71 and the surface of the push key unit 342 should be within an activity distance. The activity distance could be equal to any distance where the antenna body 3441 or antenna body 71 could communicate with a device executing near field communication while maintaining a good communication quality. Because an NFC card or other devices executing near field communication are usually put on the surface of the push button unit 342 while communicating with the near field communication antenna in the keyboard module provided by the present invention, it is helpful to obtain a good communication quality through keeping the distance between the antenna body 3441 or antenna body 71 and the surface of the push button unit 342 within the activity distance.

In summary, the drawback of prior arts can be solved by disposing the antenna unit in the keyboard module in the lower part of the electronic device in the present invention. Besides this, the efficiency of transmitting or receiving electromagnetic signals by the antenna body can be improved and the communication quality can be maintained by disposing the antenna body between the bottom of the accommodation room of the housing structure and the push elements, and further by keeping a specified distance between the antenna body and the bottom of the accommodation room. Furthermore, the technique solutions provided by the present invention could be applied on a solely-existed computer keyboard, numeric keyboard, flexible keyboard or numeric keyboard on an ATM (automatic teller machine), etc. and improves transmission efficiency of wireless antenna without affecting size, depth and manufacturing process of the keyboard itself.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keyboard module, comprising:
a housing structure having an accommodation room;
a push button unit having a plurality of push elements disposed in the accommodation room; and
a near field communication antenna unit including an antenna body disposed between a bottom of the accommodation room and the push elements, wherein the antenna body has a specified distance from the bottom of the accommodation room.

2. The keyboard module according to claim 1, wherein the housing structure comprises a keyboard frame, the keyboard frame comprises a frame body and a plurality of through holes penetrating through the frame body, the push elements correspond to the through holes, respectively, the antenna body is disposed between the bottom of the accommodation room and the frame body, and a spacing distance between the antenna body and a surface of the push button unit is shorter than an activity distance.

3. The keyboard module according to claim 1, wherein the keyboard module further includes a buffer unit disposed between the antenna body and the bottom of the accommodation room so that the bottom of the accommodation room has the specified distance from the antenna body, wherein the buffer unit is non-metal or magnetically permeable.

4. The keyboard module according to claim 1, wherein the keyboard module comprises an electromagnetically insulating structure disposed between the push elements and the bottom of the accommodation room of the housing structure, and the antenna body is disposed above the electromagnetically insulating structure.

5. The keyboard module according to claim 4, wherein the electromagnetically insulating structure is a metal grounding layer or a metal plate.

6. The keyboard module according to claim 4, wherein the near field communication antenna unit further comprises a magnetic conducting layer attached onto a surface of the antenna body adjacent to the electromagnetically insulating structure for facilitating transmission of a magnetic force through the magnetic conducting layer, thereby allowing the specified distance to be reduced, wherein the magnetic conducting layer is ferrite.

7. The keyboard module according to claim 1, wherein the antenna body is implemented with at least one of the following: a metal conductor, an iron plate, an enameled wire, a conducting line and an antenna chip on a flexible circuit board.

8. The keyboard module according to claim 1, wherein the keyboard module comprises a circuit board, and the antenna body is disposed on the circuit board.

9. An electronic device, comprising:
an upper part; and
a lower part coupled to the upper part and comprising a keyboard module, wherein the keyboard module comprises a housing structure, a push button unit and an antenna unit, the housing structure comprises an accommodation room, the push button unit comprises an electromagnetically insulating structure and a plurality of push elements, the push elements are disposed above the electromagnetically insulating structure, the antenna unit comprises an antenna body, the antenna body is disposed between the electromagnetically insulating structure and the push elements and has a specified distance from the electromagnetically insulating structure.

10. A keyboard module, comprising:
a housing structure having an accommodation room;
a push button unit having a plurality of push elements disposed in the accommodation room; and
an antenna unit having an antenna body disposed between a bottom of the accommodation room and the push elements, wherein the antenna body has a specified distance from the bottom of the accommodation room.
